(19) United States
(12) Patent Application Publication
(10) Pub. No.: US 2004/0061884 A1
(43) Pub. Date: Apr. 1, 2004

(54) Printer, method for controlling quality of printing density in printer and system therefor

(75) Inventor: Akira Yamaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/670,963

(22) Filed: Sep. 26, 2003

(30) Foreign Application Priority Data
Sep. 30, 2002 (JP) 2002-286466
Sep. 30, 2002 (JP) 2002-287183

(51) Int. Cl. G06K 1/00; G06F 15/00

(52) U.S. Cl. 358/1.9; 358/1.1

(57) ABSTRACT

The printer outputs a first test pattern for automatic measurement of image quality and a second test pattern for visual evaluation, measures automatically the image quality of the output first test pattern, determines the image quality from the obtained image quality data, inputs results of the visual evaluation of the output second test pattern, stores the image quality data, determination results and the evaluation results and displays the image quality data, the determination results, the evaluation results and history thereof, thereby performing the quality control of the output image. The method and system for controlling quality of printing density in the printer calibrate measurement results with a built-in densitometer using an external densitometer calibrated by means of a reference density sample to calibrate the built-in densitometer regularly in the printer.

### BACKGROUND OF THE INVENTION

The present invention relates to a printer, a method for controlling quality of printing density in a printer and a system therefor, and in particular to a printer equipped with a function to perform automatic QC (quality control) of image quality, a method for controlling the quality of the printing density in the printer and a system therefor by simply calibrating a densitometer built in a printer.

Conventionally, a variety of X-ray-based image capture devices for medical diagnosis have been used in the medical applications. For example, X-ray machines, CR (Computed Radiography) scanners, CT (Computed Tomography) scanners, and MRI (Magnetic Resonance Imaging) scanners are in practical use.

Medical image information acquired by these devices is regenerated on a recording material as a hard copy by way of a printer and used for medical diagnosis by a specialist.

This image-based medical diagnosis typically uses monochrome images and examines fine structures of a human body based on the density variation in an image. Thus, a diagnostic image for medical care requires high sharpness.

In order to maintain a predetermined quality concerning the density and sharpness of an image output from a printer, the QC (quality control) of a printer is required.

For example, as a prior art printer quality control, a printer quality control system is known which allows the printer state to be grasped at the manufacturer without having to dispatch a technician, by transmitting the printer information externally to make the printer information available for example at the manufacturer (refer to JP 2002-55800 A).

The printer quality control system, as shown in FIG. 16, comprises: a user's network 93 including a printer 90, a PC 91 as a host computer and an Internet server 92 interconnected via a LAN; and a manufacturer's network 97 including a quality control server 94 for storing and controlling the printer quality control data, a PC 95 as a terminal and an Internet server 96 interconnected via a LAN; the user's network 93 and the manufacturer's network 97 interconnected via an Internet 98.

In case a fault has occurred during operation of the printer 90, the system transmits the history data on the state and operation of the printer 90 to the manufacturer's network 97 via the Internet 98.

However, the prior art printer quality control system transmits the information on the printer from the user's premise to the manufacturer via the Internet only when a fault has taken place in the printer. The printer image quality QC means is not centralized on the printer. The regular printer quality control tasks performed by the user remain complicated and burdensome.

In particular, in case the printer quality control is necessary for maintaining a predetermined quality concerning the density of an image output from a printer, in the prior art, the density of an image output from the printer has been measured by an external densitometer or a densitometer built into the printer to perform quality control of printing density in the printer.

As mentioned earlier, regular quality control of the printing density in the printer by measuring the density of an output image on an external densitometer as in the prior art places a heavy load on the operator.

While the density quality control using a built-in densitometer reduces such a load on the operator, a variation in the density value caused by secular change cannot be recognized by the image capture device, thus preventing correct density quality control.

### SUMMARY OF THE INVENTION

The invention has been accomplished in view of the prior art problems. A first object of the invention is to provide a printer equipped with an image quality control function which allows automatic regular printer quality control tasks on a standalone printer at the user's premise thereby reducing the workload of the printer quality control tasks.

The invention has been accomplished in view of the prior art problems. A second object of the invention is to provide a method for controlling the quality of the printing density in the printer and a system therefor which facilitate the regular quality control tasks and allow the density quality control using a unified standard even in case a plurality of printers are arranged, by calibrating the densitometer built into a printer against the measurement values on an external densitometer at the printer location as a reference.

In order to attain the first object described above, a first aspect of the present invention provides a printer having a function to control quality of an output image, comprising output means for outputting a first test pattern for automatic measurement of image quality and a second test pattern for visual evaluation, measuring means for automatically measuring the image quality of the first test pattern for the automatic measurement of the image quality, determining means for determining the image quality from image quality data obtained through the automatic measurement by means of the measuring means to obtain determination results, inputting means for inputting evaluation results of the visual evaluation of the second test pattern for the visual evaluation, storage means for storing the image quality data obtained through the automatic measurement, the determination results and the evaluation results of the visual evaluation, and display means for displaying the stored image quality data, the determination results, the evaluation results of the visual evaluation and history thereof.

Preferably, the first test pattern for the automatic measurement of the image quality pertains to at least one of density, format and sharpness.

Preferably, the second test pattern for the visual evaluation is at least one of an SMPTE pattern and a standard clinical image.

Preferably, the printer outputs the first test pattern for the automatic measurement of the image quality and the second test pattern for the visual evaluation on a single sheet.

Further, preferably, the printer is a medical printer that outputs a transmitting monochrome film.

In order to attain the second object described above, a second aspect of the present invention provides a method for controlling quality of printing density in a printer, comprising the steps of outputting a test pattern for density measurement from the printer, measuring first and second density values of the test pattern for the density measurement on a built-in densitometer built into the printer and an external densitometer calibrated using a reference density sample whose density values have been measured with a densitometer calibrated in accordance with national standards, generating a calibration table for calibrating the first density values in the built-in densitometer based on a difference between the first and second density values obtained through the measuring step, storing the calibration table within the printer, and performing quality control of the printing density in the printer based on third density values obtained by calibrating the first density values in the built-in densitometer with the calibration table.

Moreover, in order to attain the second object, a third aspect of the present invention provides a system for controlling quality of printing density in a printer, comprising a reference density sample whose density values have been measured with a densitometer calibrated in accordance with national standards, an external densitometer calibrated using the reference density sample, and the printer, including, test pattern output means for outputting a test pattern for density measurement, a built-in densitometer for measuring first density values of the test pattern for the density measurement, input means for inputting second density values of the test pattern for the density measurement obtained by measuring on the external densitometer, calibration table generation means for generating a calibration table for calibrating the first density values in the built-in densitometer based on the input second density values of the test pattern for the density measurement obtained by measuring on the external densitometer and the first density values of the test pattern for the density measurement obtained by measuring on the built-in densitometer, and storage means for storing the generated calibration table, wherein the system calibrates the first density value in the built-in densitometer by the stored calibration table.

Preferably, the printer further comprises at least one of storage means for storing quality control information and display means for displaying the quality control information.

### BRIEF DESCRIPTION OF THE DRAWINGS

FIG. 1 is a block diagram showing the general configuration of an embodiment of a printer equipped with a quality control (QC) function of an output image according to the invention;

FIG. 2 is an explanatory drawing illustrating a pattern sheet including a test pattern for automatic measurement and a test pattern for visual evaluation according to this embodiment;

FIG. 3A is an explanatory drawing illustrating a test pattern for visual evaluation according to this embodiment;

FIG. 3B is another explanatory drawing illustrating a test pattern for visual evaluation according to this embodiment;

FIG. 4 is an explanatory drawing illustrating automatic measurement in the regular quality control according to this embodiment;

FIG. 5 is an explanatory drawing illustrating automatic image quality measurement in a routine according to this embodiment;

FIG. 6 is an explanatory drawing illustrating a density measurement pattern according to this embodiment;

FIG. 7 is a diagram showing the output of density measurement results in a routine according to this embodiment;

FIG. 8 is a block diagram showing the general view of an embodiment of a system for controlling the quality of the printing density in the printer according to the invention;

FIG. 9 is an explanatory drawing illustrating a reference density sample.

FIG. 10 is an explanatory drawing illustrating a test pattern for density measurement according to this embodiment;

FIG. 11 is a flowchart showing a regular calibration procedure for a built-in densitometer in the method for controlling the quality of the printing density in the printer according to this embodiment;

FIG. 12 is a diagram showing an exemplary calibration table according to this embodiment;

FIG. 13 is a flowchart showing a regular density quality control procedure in the method for controlling the quality of the printing density in the printer according to this embodiment;

FIG. 14 is a diagram showing an exemplary method for displaying the regular density quality control results according to this embodiment;

FIG. 15 is a diagram showing an exemplary method for displaying the regular density quality control result history according to this embodiment; and

FIG. 16 is a general configuration of a prior art printer quality control system.

### DETAILED DESCRIPTION OF THE INVENTION

A printer, a method for controlling the quality of the printing density in the printer and a system therefor according to the invention are described below based on the preferred embodiments shown in the attached drawings.

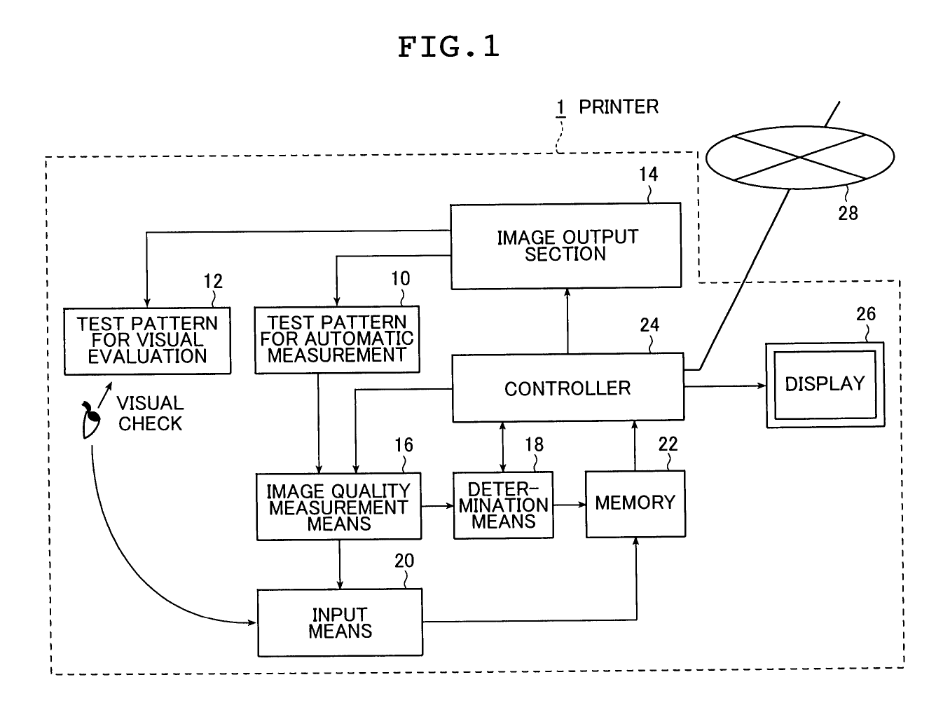

A printer according to the first aspect of the invention is described below with reference to FIGS. 1 through 7.

FIG. 1 is a block diagram showing the general configuration of an embodiment of a printer equipped with a quality control (QC) function of an output image according to the first aspect of the invention.

As shown in FIG. 1, a printer 1 according to this embodiment comprises an image output section 14 for outputting a test pattern for automatic measurement 10 and a test pattern for visual evaluation 12, image quality measurement means 16, determination means 18, input means 20, a memory 22, and a controller 24 for controlling the operation of each section of the printer 1. To the controller 24 is connected a display 26 for displaying the quality control results.

The controller 24 is connected to an external system via a network 28 such as the Internet.

A printer according to this embodiment is preferably, but not limited to, a printer for medical applications which outputs a transmitting monochrome film. Such a printer for medical applications is preferably a dry printer which does not require a wet development process, and preferably a thermal recording device using a thermal head or a heat mode laser, or a photosensitive thermal color formation image recording device using a photosensitive thermal development recording material or a photosensitive thermal recording material.

The test pattern for automatic measurement 10 for automatic measurement of an image quality and the test pattern for visual evaluation 12 for visual evaluation of an image quality by the human eye are output from the image output section 14 based on the data previously provided in the memory 22.

The picture quality to be automatically measured is for example the density, format or sharpness. Automatic measurement is made on at least one of these image qualities. For example, in the case of a pattern for density measurement, a pattern for measuring three densities: high density, medium density and low density is used.

The test pattern for visual evaluation 12 may be an SMPTE pattern for visual check or a standard clinical image in practical skill such as a chest or knee X-ray picture. The SMPTE pattern is used to inspect a distortion, space resolution, contrast or artifacts of an image. The standard clinical image is used to check for a pseudo contour or check whether the image serves as a diagnostic image.

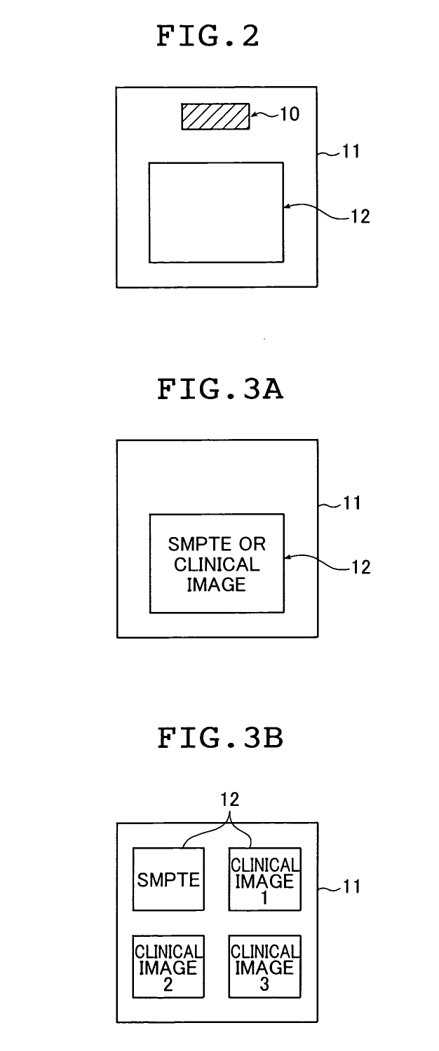

As shown in FIG. 2, the test pattern for automatic measurement 10 and the test pattern for visual evaluation 12 are preferably recorded on a single pattern sheet 11. In this way, a single pattern sheet 11 may be used for both automatic measurement and visual evaluation, which reduces the loss of output films and ensures effective operation.

The test pattern for visual evaluation 12 may include, as shown in FIG. 3A, an SMPTE pattern or a standard clinical image output on a single pattern sheet 11. Or, as shown in FIG. 3B, the test pattern for visual evaluation 12 may include an SMPTE pattern and a plurality of standard clinical images output on a single pattern sheet 11, called all-in-one output.

The image quality measurement means 16 is measurement means such as a densitometer built into the printer 1. When the test pattern for automatic measurement 10 is output from the image output section 14 under control of the controller 24, the image quality measurement means 16 makes automatic measurement in the printer 1 before the test pattern for automatic measurement 10 is output from the printer 1.

The measurement data is transmitted to the determination means 18. The determination means 18 determines the data measured by the image quality measurement means 16. The measurement data and the determination results are recorded into the memory 22.

The input means 20 is used to manually input the results of visual evaluation by a human on the test pattern for visual evaluation 12.

In case automatic measurement is unavailable in the printer 1, such as in case the image quality measurement means 16 such as a built-in densitometer has gone faulty or the image quality measurement means 16 is uninstalled, the measurement values obtained by measuring the test pattern for automatic measurement 10 on measurement means external to the printer 1 may be input from the input means 20. Or, such external measurement means and the printer 1 may be interconnected to allow direct data input.

The results of visual evaluation and the measurement values input from the input means 20 are stored into the memory 22.

The memory 22, as mentioned above, stores as quality control data the automatically measured data (image quality data), its determination results, and the image quality inspection results obtained through visual evaluation.

The display 26 displays the quality control data or the history of quality control data stored in the memory 22. The display 26 is not particularly limited but may be an operation panel of a small-sized LCD.

The printer 1 is connected to another printer, a system including a printer, or a printer quality control system at the printer manufacturer so as to transmit quality control data to the outside.

The printer 1 may be capable of printing quality control data from the image output section 14.

The printer 1 preferably has a function to automatically calibrate the built-in image quality measurement means 16 such as a densitometer. This calibration method is not particularly limited but may be a method for measuring a sample serving as a reference on built-in measurement means 16 and comparing the measurement results with a correct value for inspection.

The operation of this embodiment is described below.

First, the regular quality control will be described. In the regular quality control, the quality control program in the controller 24 may be started automatically, for example, when the printer is powered at the start of work. The operator may select a quality control menu on the input means 20 to start the quality control program in the controller 24.

Next, the controller 24 reads data for a test pattern from the memory 22 and transmits the data to the image output section 14, which output a pattern sheet 11 on which are recorded a test pattern for automatic measurement 10 and a test pattern for visual evaluation 12.

In this practice, the test pattern for automatic measurement 10 on the pattern sheet 11 is measured by the image measurement means 16 built into the printer 1 before the pattern sheet 11 is output from the printer 1.

In case the image quality measurement pertains to the density, the test pattern for automatic measurement 10 is a pattern for density measurement comprising measuring three density patterns: high density, medium density and low density patterns.

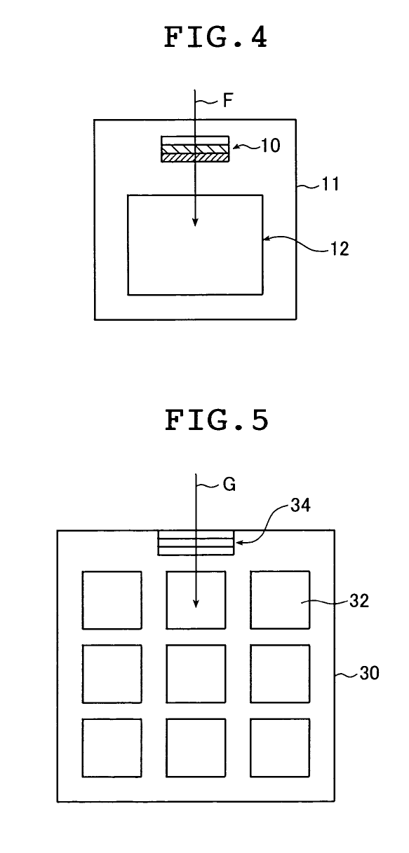

The density measurement is performed by scanning over the pattern sheet 11 with a densitometer, for example as shown by an arrow F in FIG. 4. The densitometer measures the three densities at the high, medium and low densities over the density measurement pattern. The data measured by the image quality measurement means 16 (for example the densitometer) is transmitted to the determination means 18.

The determination means 18 makes determination based on the measurement values and transmits the measurement data and the measurement results (quality control data) to the memory 22. This determination is made by comparing the correct value of data previously stored in the memory 22 as a density measurement pattern with the measurement value obtained by measuring the output density measurement pattern.

The pattern sheet 11 which has undergone automatic measurement of image quality is output from the printer 1. The operator performs visual inspection of the test pattern for visual evaluation 12 recorded on the pattern sheet 11 and inputs the inspection results to the printer 1 via the input means 20. The input inspection results are stored into the memory 22.

The quality control results are displayed on the display 26, either automatically or based on an instruction by the operator from the input means 20. The quality control results may be output at the same time as a hard copy from the image output section 14.

The quality control by the routine will be described.

In this case, as shown in FIG. 5, a practical image (clinical image) 32 is recorded on a film 30 output. When the film 30 is observed on a film viewer, a pattern for density measurement 34 is recorded, for example, on the part of the film 30 concealed by the member of the film viewer.

In a routine, the built-in densitometer (image quality measurement means 16) is used to measure the density on the pattern for density measurement 34 in the printer 1 each time the film 30 is output.

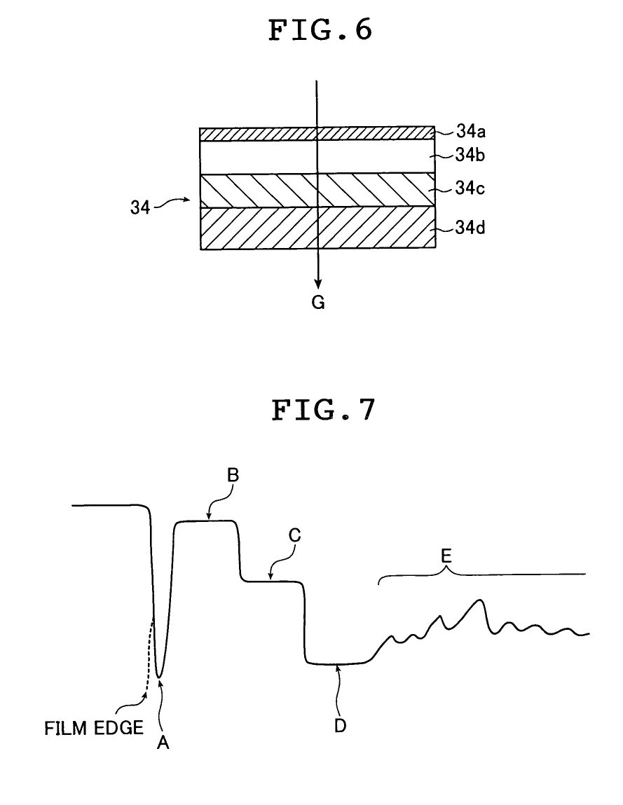

This measurement is made by scanning over the film 30 with the built-in densitometer as shown by an arrow G in FIG. 5. FIG. 6 shows an enlarged view of the pattern for density measurement 34.

As shown in FIG. 6, the pattern for density measurement 34 comprises a marker 34a indicating the start of the pattern for density measurement 34, and high-, medium- and low-density patterns 34b, 34c and 34d.

FIG. 7 shows the output of the measurement results by the densitometer. As shown by a sign A in FIG. 7, a film edge and the marker 34a are detected first. Then the sections B, C, D corresponding to the density patterns 34b, 34c and 34d are output. After that, the output value for the practical image indicated by a sign E is detected.

In this way, automatic density measurement is made per film output in a routine. In case the measured density value exceeds a preset allowable range, the controller 24 displays a warning on the display 26.

The automatic density measurement need not be performed per output but may be performed per predetermined number of sheets output, for example 100 sheets.

In this way, automatic density measurement is made in a routine so that the user need not be conscious of conducting a test, which substantially facilitates the density quality control.

While the density quality control has been described as an image quality, automatic image quality control may be made concerning other image quality elements such as the format and the sharpness on a standalone printer.

As mentioned above, according to this embodiment, it is possible to automatically and easily perform regular quality control tasks (constancy test) on a standalone printer.

The quality control results may be stored into the memory 22 or displayed on the display 26 or only the quality control results may be output as a hard copy. Also, information to identify the quality control data may be recorded on a film to be output.

The automatic image quality measurement means need not be provided in a printer. A measurement instrument external to the printer and the printer may be interconnected so as to input measurement data to the printer.

As mentioned above, according to the first aspect of the invention, it is possible to perform regular quality control of the printer image quality on a standalone printer, automatically and in an easy fashion.

The printer according to the first aspect of the invention is basically configured as mentioned above.

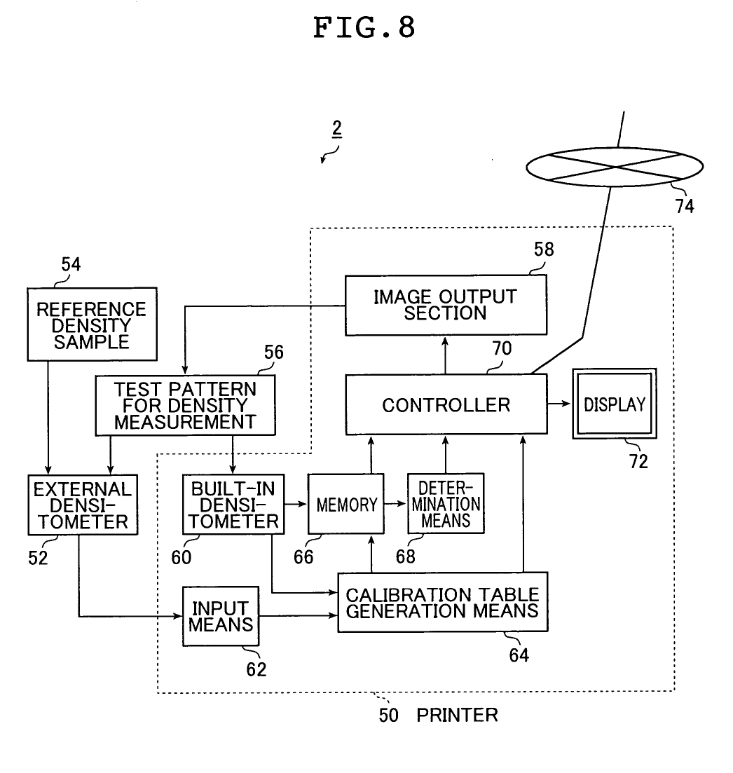

Next, referring to FIGS. 8 through 15, a method for controlling the quality of the printing density in the printer and a system therefor according to the second and third aspects of the invention are described below.

One embodiment of the method for controlling the quality of the printing density in the printer and the system therefor according to the second and third aspects of the invention refers to a method and a system in which an external densitometer calibrated with a reference density sample is provided to regularly calibrate a densitometer built into a printer for density quality control of the printer, the density values of a test pattern for density measurement output from the printer are measured by the built-in densitometer and the external densitometer, the difference between the density measurement values obtained is used to generate a calibration table for calibrating the density value of the built-in densitometer, and the calibration table is used to calibrate the density measurement value in each measurement on the built-in densitometer.

FIG. 8 is a block diagram showing the general view of an embodiment of a system for controlling quality of printing density in a printer (hereinafter referred to simply as “a printer density quality control system”) according to the third aspect of the invention for performing a method for controlling the quality of the printing density in the printer according to the second aspect of the invention.

As shown in FIG. 8, a system 2 for controlling the quality of the printing density in the printer according to this embodiment basically comprises a printer 50 as a target of density quality control, an external densitometer 52 for calibrating the density value of a densitometer built into the printer 50, and a reference density sample 54 for calibrating the external densitometer 52.

The printer 50 comprises: an image output section 58 for outputting a test pattern for density measurement 56 or a film image such as a clinical image in regular tasks; a built-in densitometer 60 provided in the printer 50 for the regular density quality control of the printer; input means 62 for inputting the measurement data from the external densitometer 52 into the printer 50; calibration table generation means for generating a calibration table for calibrating the density value of the built-in densitometer 60 based on the density values of the built-in densitometer 60 and the external densitometer 52; a memory 66 for storing the calibration table generated and other various data; determination means 68 for making determination in the regular density quality control; and a controller for controlling these sections of the printer 50; and a display 72 for displaying various data and inspection results. Further, the printer 50 is connected to an external system via a network 74.

The external densitometer 52 is installed as a standard densitometer in a facility where the printer 50 is installed. The external densitometer 52 is used to calibrate the built-in densitometer 60 in the printer 50 in case the properties of built-in densitometer 60 have undergone a secular change.

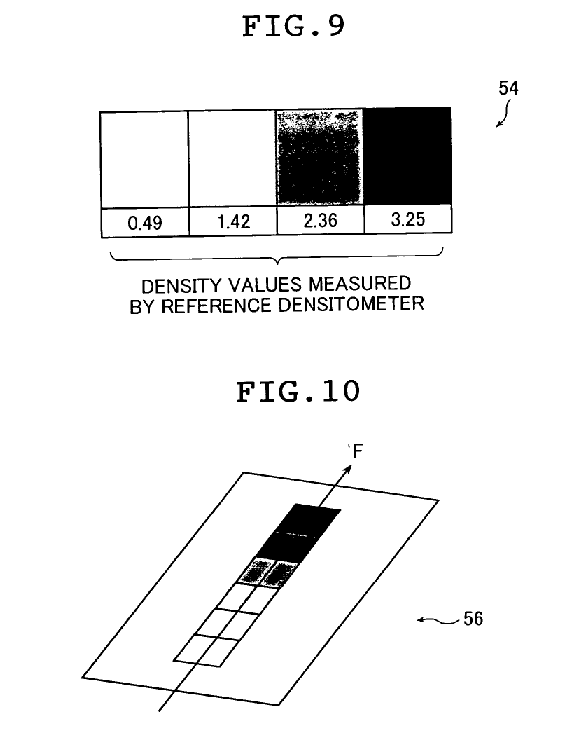

Thus, the external densitometer 52 must be regulated so as to indicate a correct density value at any time. A reference density sample 54 is used to calibrate the external densitometer 52. The reference density sample 54 is a sample whose density values have been measured by a densitometer calibrated in accordance with national standards (standard densitometer). For example, as shown in FIG. 9, the density of a test sample measured by the standard densitometer is 3.25.

The image output section 58 of the printer 50 outputs a test pattern for density measurement 56 during calibration of the built-in densitometer 60 made at regular predetermined intervals and the printing density quality control of the printer (hereinafter referred to simply as “printer density quality control”) in the regular tasks. The image output section 58 also outputs regular images (such as clinical images when the printer is installed in a hospital) onto a film in the regular tasks. In case it is installed in a hospital and used for medical applications, the printer 50 is preferably, but not limited to, a dry printer such as a thermal recording device using a thermal head or a heat mode laser which does not require a wet development process as a printer for medical care which outputs a transmitting monochrome film.

The test pattern for density measurement 56 undergoes density measurement by the built-in densitometer 60 in the regular printer density quality control. In the regular calibration of the built-in densitometer 60, the density of the test pattern for density measurement 56 is measured by both the external densitometer 52 and the built-in densitometer 60 in order to compare the density measurement values output from the external densitometer 52 and the built-in densitometer 60.

To this end, a plurality of densities of the test pattern for density measurement 56 are output in multiple steps, as shown in FIG. 10. In case the test pattern for density measurement 56 is to be measured by the densitometer 52 or 60, the densitometer 52 or 60 scans over the test pattern for density measurement 56 to measure its density, as shown by an arrow F in FIG. 10.

The built-in densitometer 60 which is installed in the printer 50 typically performs automatic density measurement of the test pattern for density measurement 56 output from the image output section 58 in the printer 50 before it is output from the printer 50. The measurement results are typically transmitted to the memory 66.

In the regular calibration of the built-in densitometer 60, the results of the measurement of the test pattern for density measurement 56 output from the image output section 58 are transmitted to calibration table generation means 64 mentioned later.

The external densitometer 52 is preferably, but not limited to, a densitometer for measuring the density of a density of diffused light which has passed through a filter having a spectral distribution indicated by a human luminosity curve about a wavelength of 550 nm. The built-in densitometer 60 may have the same configuration as the external densitometer 52 but may be a densitometer using a laser or LED having a separate spectral distribution. This is because there is provided a calibration table for the built-in densitometer 60 so that calibration is made possible using the density value of the external densitometer 52.

The input means 62 is used to input the measurement results of the test pattern for density measurement 56 by the external densitometer 52 to the printer 50. The input means 62 may be an operation system including a keyboard from which the operator manually inputs data. Or, the external densitometer 52 and the printer 50 may be interconnected to allow automatic input of data in a direct way.

The measurement results by the external densitometer 52 input is transmitted to the calibration table generation means 64.

The calibration table generation means 64 generates a calibration table (LUT) for calibrating the density value of the built-in densitometer 60 based on the difference between the density measurement values of the test pattern for density measurement 56 by the built-in densitometer 60 and the external densitometer 52.

The calibration table thus generated is stored into the memory 66 and used for the regular printer density quality control. This will be detailed later.

The memory 66, as mentioned earlier, stores the calibration table for calibrating the density value of the built-in densitometer 60 as well as the density value of the built-in densitometer 60 in the regular printer density quality control. The memory 66 also stores the quality control data (measurement values, determination results, inspection dates and so on).

The determination means 68 determines whether the density value measured by the built-in densitometer 60 is within the allowable range of a reference value previously given from the density value of the reference density sample 54.

A controller 70 controls each section of the printer 50 as well as displays in a predetermined format the above determination results in the regular printer density quality control and various quality control data or quality control history on the display 72.

In this way, the display 72 displays in a predetermined format the determination results in the regular printer density quality control and various quality control data such as measurement values, determination results, inspection dates or quality control history on the display 72.

The printer 50 is connected to the network 74 and transmits the above quality control data to a quality control management apparatus via the network 74.

The method for controlling the quality of the printing density in the printer as an operation of the system 2 for controlling the quality of the printing density in the printer according to this embodiment is described below.

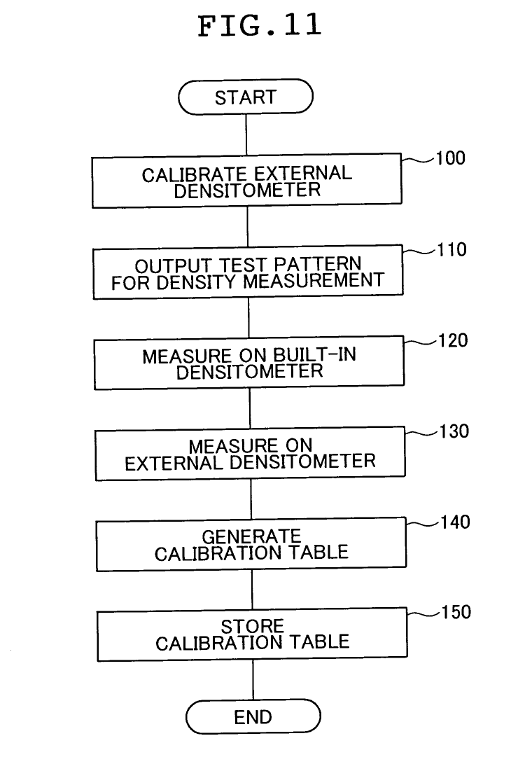

Regular calibration of the density value of the built-in densitometer 60 will be described referring to the flowchart in FIG. 11. Calibration of the built-in densitometer 60 is made on a regular basis, for example once every half year, but this interval is not limited thereto.

In step 100 in FIG. 11, the external densitometer 52 is calibrated. In the calibration, the reference density sample 54 illustrated in FIG. 9 is used. The reference density sample 54 has density values measured by a densitometer calibrated in accordance with national standards (standard densitometer). As shown in FIG. 9, several types of density samples, from low density to high density, are arranged in steps.

In case the measurement values of the reference density sample 54 measured by the external densitometer 52 differs from those of the reference density sample 54, the trimmer (variable volume for minute adjustment) attached on the external densitometer 52 is to be adjusted to calibrate the external densitometer 52 so that the density values will match.

Next, in step 110, the test pattern for density measurement 56 is output from the image output section 58 of the printer 50. The test pattern for density measurement 56 is output with the densities arranged in steps, from low density to high density, as shown in FIG. 10.

After the test pattern for density measurement 56 is measured by the built-in densitometer 60 in step 120, the test pattern for density measurement 56 is output from the printer 50.

In the regular printer density quality control mentioned later, the density values obtained by measuring the test pattern for density measurement 56 by the built-in densitometer 60 are calibrated as per the calibration table stored in the memory 66. The measured density value is not calibrated in case the built-in densitometer 60 itself is calibrated as in this example.

In step 103, the test pattern for density measurement 56 is measured by the external densitometer 52. Measurement of the test pattern for density measurement 56 is made by scanning over the test pattern for density measurement 56 as shown by an arrow F in FIG. 10.

The density measurement value obtained by the built-in densitometer 60 is directly transmitted to the calibration table generation means 64. The density measurement value obtained by the external densitometer 52 is input to the calibration table generation means 64 from the input means 62.

Assume that the test pattern for density measurement 56 comprises the 17-step density levels from low density to high density in STEP 1 through STEP 17. Density measurement values obtained by respective densitometers at each density level are obtained on the calibration table generation means 64 as shown in Table 1.

TABLE 1

| | Built-in densitometer | External densitometer |
|---|---|---|
| Density level | x | y |
| STEP 1 | 0.15 | 0.16 |
| STEP 2 | 0.21 | 0.22 |
| STEP 3 | 0.27 | 0.30 |
| . . . | . . . | . . . |
| STEP 16 | 2.74 | 2.88 |
| STEP 17 | 3.09 | 3.15 |

Next, in step 140, on the calibration table generation means 64, these density measurement values are used to generate a calibration table in the following way.

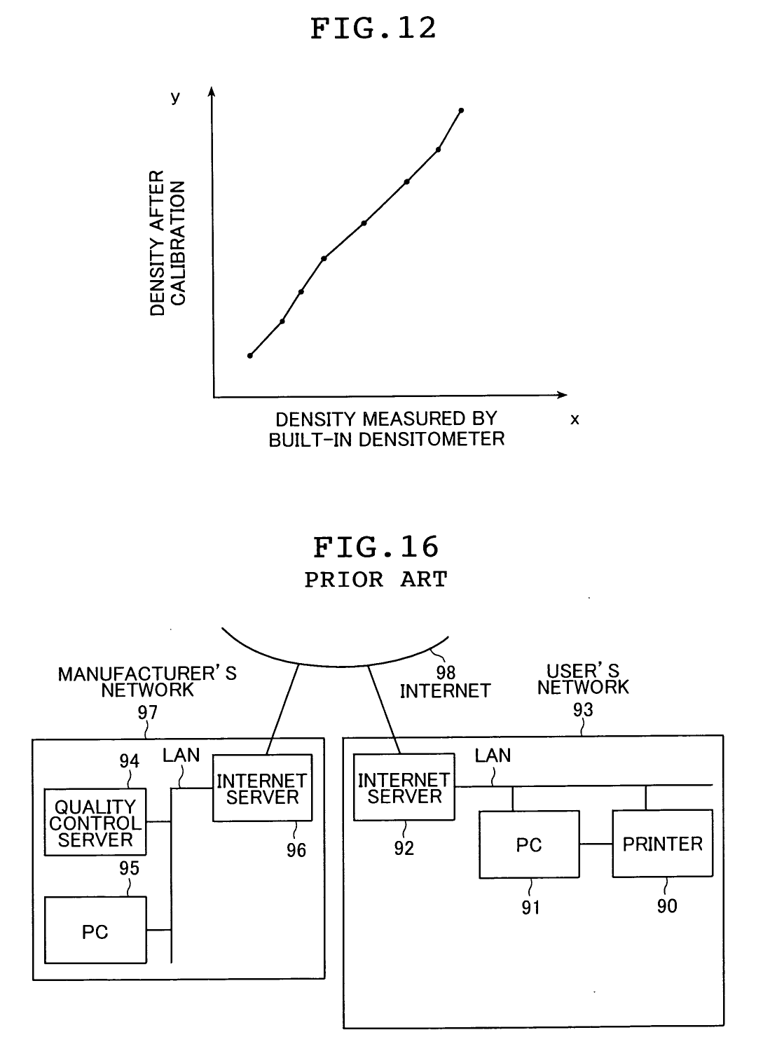

At each density level, at each point where the density measurement value x of the built-in densitometer 60 and the density measurement value y of the external densitometer 52 differ from each other, the density measurement value y of the external densitometer 52 is assumed as a density value y after calibration. At a density level other than these 17 points, the difference between the density measurement value x of the built-in densitometer 60 and the density measurement value y of the external densitometer 52 is obtained, and the difference is used to perform quadratic interpolation from the sequence of 17 dots, and, as a calibration curve representing the relationship between the density measurement value x of the built-in densitometer 60 and the density measurement value y after calibration (also represented as y), a calibration curve (y=f(x)) shown in FIG. 12 is generated.

In this way, by calibrating the density measurement value x of the built-in densitometer 60, the density measurement value of the built-in densitometer 60 is correctly calibrated with the reference density sample 54 and equals the density measurement value of the external densitometer 52 as a reference.

Next, in step 150, the calibration table thus generated is stored into the memory 66.

In this way, by calibrating the calibration table for calibrating the density measurement value of the built-in densitometer 60 by using the external densitometer 52 calibrated using the reference density sample 54 thus regularly updating the calibration table, it is possible to perform regular printer density quality control with the constantly corrected built-in densitometer 60.

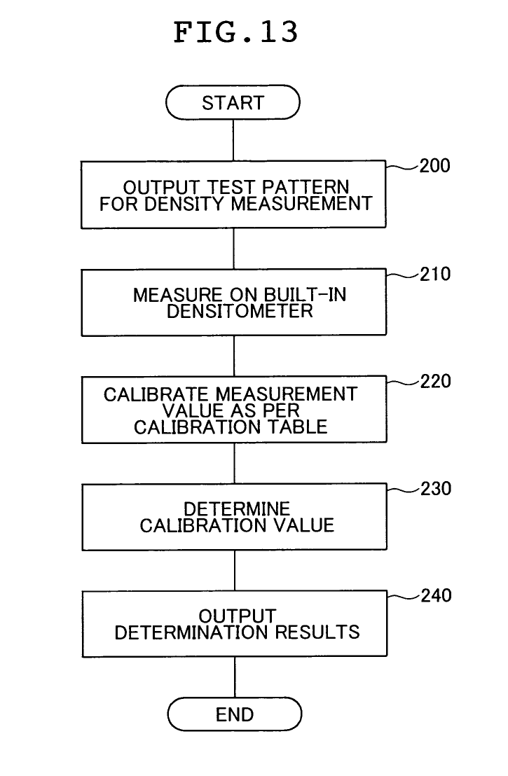

Next, the regular printer density quality control is described below referring to the flowchart in FIG. 13.

In the regular printer density quality control, it is assumed that regular calibration of the built-in densitometer 60 has been made and the calibration table has been generated and stored in the memory 66.

In step 200, the image output section 58 outputs the test pattern for density measurement 56 as shown in FIG. 10.

In step 210, the test pattern for density measurement 56 is scanned by the built-in densitometer 60 as shown by the arrow in FIG. 10 to perform automatic density measurement. The density measurement values are transmitted to the memory 66.

In step 220, the density measurement values transmitted to the memory 66 are calibrated as per the calibration table stored in the memory 66. That is, a density value after calibration yᵢ=f(xᵢ) is obtained from the density measurement value xᵢ of the built-in densitometer 60 at the density level i (STEP i).

In step 230, the determination means 68 determines the density value after calibration. This process determines whether the density value after calibration is within a predetermined allowable range (for example the allowable width Δy) with respect to a previously given reference value y_{ref}.

In case the density value yᵢ is within the range of y_{ref}±Δy, the determination is OK. Otherwise, the determination is NG.

In this way, determination is made for all the density levels (17 steps from STEP 1 through STEP 17 in the above example).

In step 240, the determination results are displayed on the display 72.

A method for displaying the determination results on the display 72 is not particularly limited but various methods may be employed.

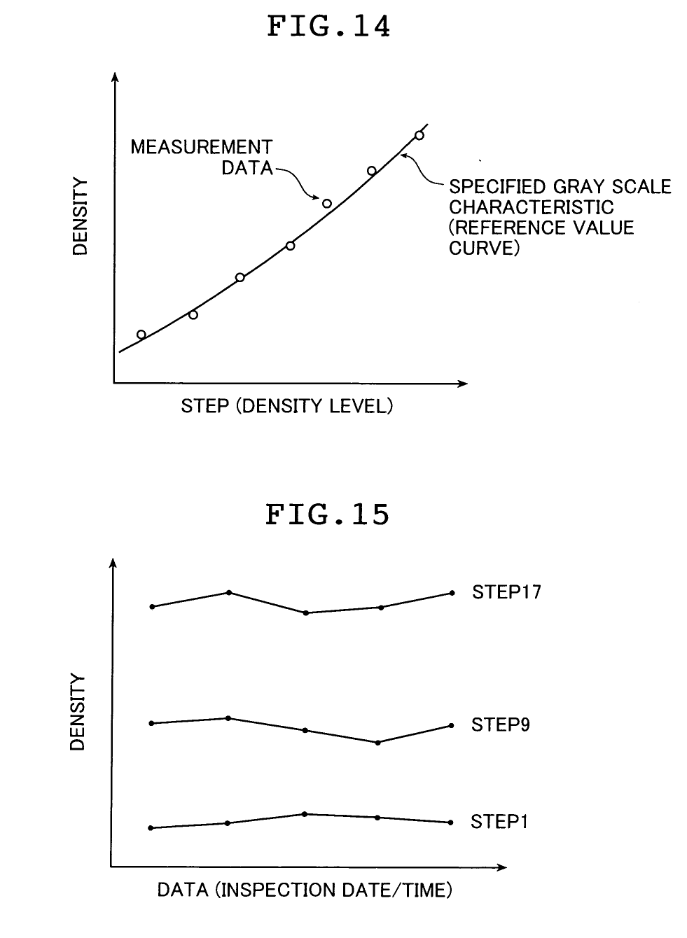

For example, as shown in FIG. 14, measurement values may be plotted on a graph of specified gray scale characteristic (reference value curve) where the horizontal axis is laid off in steps and the vertical axis in step-based densities, or represented in a table, as shown in Table 2 below.

In case the measurement values are represented on a graph as shown in FIG. 14, determination is OK for example in case a point representing each measurement value is a circle and NG in case a bullet.

TABLE 2

| | Density |
|---|---|
| | (measurement |
| Density level | value) |
| STEP 1 | 0.18 |
| STEP 2 | 0.34 |
| STEP 3 | 0.53 |
| . . . | . . . |
| STEP 17 | 2.92 |

On the display 72, as shown in FIG. 15, the horizontal axis may be laid off in inspection dates/times and vertical axis density values so as to display a history of density values obtained by measuring the test pattern for density measurement 56 by the built-in densitometer 60.

In this way, by displaying a history, it is possible to grasp the secular change of the built-in densitometer 60.

In this way, by generating a calibration table for regularly calibrating the built-in densitometer 60 by using the external densitometer 52 whose density value has been calibrated with the reference density sample 54 whose density value is assured by the national standards, the sole process regularly required is automatic density measurement on the test pattern for density measurement 56 by the built-in densitometer 60, which simplifies the printer density quality control.

This substantially facilitates the regular printer density quality control.

In case a plurality of printers are provided in a facility, a plurality of calibration tables are required, while making it possible to perform density quality control using a standard unified with a single external densitometer as a standard.

The density quality control results may be displayed on a display or output as a hard copy from the image output section 58. The quality control data identifying information may be recorded on (part of) a film where regular images are output.

The density quality control data may be transmitted as required to external (for example the printer manufacturer's) quality control management apparatus via the network 74.

As mentioned earlier, according to the second and third aspects of the invention, a built-in densitometer is regularly calibrated using an external densitometer whose density value has been calibrated with a reference density sample. Thus the sole process regularly required is automatic density measurement on the test pattern for density measurement by the built-in densitometer, which simplifies the printer density quality control and substantially facilitates the regular printer density quality control.

The method for controlling the quality of the printing density in the printer and the system therefor according to the second and third aspects of the invention are as mentioned above.

While the printer, the method for controlling the quality of the printing density in the printer and the system therefor according to the invention has been detailed referring to various embodiments, the invention is not limited to the foregoing embodiments but various changes and modifications can be made in it without departing from the spirit and scope thereof.

What is claimed is:

1. A printer having a function to control quality of an output image, comprising:
output means for outputting a first test pattern for automatic measurement of image quality and a second test pattern for visual evaluation;
measuring means for automatically measuring the image quality of said first test pattern for the automatic measurement of the image quality;
determining means for determining the image quality from image quality data obtained through said automatic measurement by means of said measuring means to obtain determination results;
inputting means for inputting evaluation results of the visual evaluation of said second test pattern for the visual evaluation;
storage means for storing said image quality data obtained through said automatic measurement, said determination results and said evaluation results of said visual evaluation; and
display means for displaying said stored image quality data, said determination results, said evaluation results of the visual evaluation and history thereof.

2. The printer according to claim 1, wherein said first test pattern for the automatic measurement of the image quality pertains to at least one of density, format and sharpness.

3. The printer according to claim 1, wherein said second test pattern for the visual evaluation is at least one of an SMPTE pattern and a standard clinical image.

4. The printer according to claim 1, wherein said printer outputs said first test pattern for the automatic measurement of the image quality and said second test pattern for the visual evaluation on a single sheet.

5. The printer according to claim 1, wherein said printer is a medical printer that outputs a transmitting monochrome film.

6. A method for controlling quality of printing density in a printer, comprising the steps of:
outputting a test pattern for density measurement from said printer;
measuring first and second density values of said test pattern for the density measurement on a built-in densitometer built into said printer and an external densitometer calibrated using a reference density sample whose density values have been measured with a densitometer calibrated in accordance with national standards;
generating a calibration table for calibrating said first density values in said built-in densitometer based on a difference between said first and second density values obtained through said measuring step;
storing said calibration table within said printer; and
performing quality control of the printing density in the printer based on third density values obtained by calibrating said first density values in said built-in densitometer with said calibration table.

7. A system for controlling quality of printing density in a printer, comprising:
a reference density sample whose density values have been measured with a densitometer calibrated in accordance with national standards;
an external densitometer calibrated using said reference density sample; and
the printer, including:
test pattern output means for outputting a test pattern for density measurement;
a built-in densitometer for measuring first density values of said test pattern for the density measurement;
input means for inputting second density values of said test pattern for the density measurement obtained by measuring on said external densitometer;
calibration table generation means for generating a calibration table for calibrating said first density values in said built-in densitometer based on said input second density values of said test pattern for the density measurement obtained by measuring on said external densitometer and said first density values of said test pattern for the density measurement obtained by measuring on said built-in densitometer; and
storage means for storing said generated calibration table;
wherein said system calibrates the first density value in said built-in densitometer by said stored calibration table.

8. The system for controlling the quality of the printing density in the printer according to claim 7, wherein said printer further comprises at least one of storage means for storing quality control information and display means for displaying the quality control information.
